(19) United States
(12) Patent Application Publication
(10) Pub. No.: US 2013/0076053 A1
(43) Pub. Date: Mar. 28, 2013

(54) Bucket sling

(71) Applicant: Daniel Martin Mayer, Rocky River, OH (US)

(72) Inventor: Daniel Martin Mayer, Rocky River, OH (US)

(21) Appl. No.: 13/134,347

(22) Filed: Sep. 22, 2011

(51) Int. Cl. B66C 1/12; B66C 1/18

(52) U.S. Cl. 294/74

(57) ABSTRACT

An improved method and apparatus for hoisting and lowering a five gallon buckets by the use of a rope and pulley system and or hand carried. This method utilizes a bucket sling that a five gallon plastic and or steel bucket and or pail fits into. The bucket sling is constructed of two pieces, the main portion of the bucket sling FIG. 1, is formed by a single strap of material with a loop formed out of the material on one end of the strap forming an eyelet. The free un-looped end of the strap is fed under the five gallon bucket over the top 3 of the five gallon bucket through the eyelet 1 back around the circumference 4 of the five gallon bucket and the opposite end of the main strap is then fed through and connected to the inside edge of the material that forms the eyelet 1.

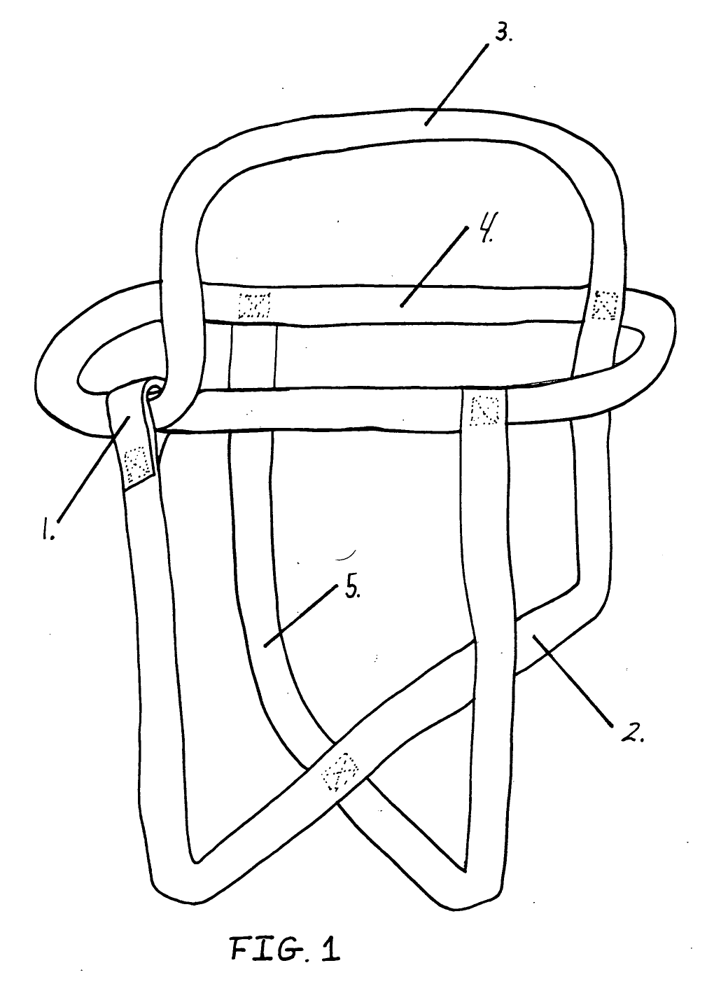

As shown in FIG. 1 the bucket sling main strap has four components 1,2,3,4, and a single alignment 5 strap to keep the five gallon bucket centered within the engagement portion of the main strap. In addition a clip, hasp, or carabiner may be attached to the main portion of the handle to increase ease of attachment and detachment to hoisting line. The bucket sling may be engaged with five gallon buckets of differing heights and circumferences. In an alternative embodiment the bucket sling may be affixed with five gallon bucket to a permanent or temporary stationary attachment point for storage or material collection, providing a safer system for the storage, suspension, and transportation of five gallon pails.

### BACKGROUND OF THE DISCLOSURE

Five gallon buckets are commonly used in many industries for the moving, storing, collection and relocation of tools and materials. Such five gallon buckets are typically placed near the point which the contents will be collected, used, stored, deposited or being relocated. When desired the five gallon bucket would be then hoisted or lowered to a second location for use of material, disposal of debris, and tool relocation. Traditionally five gallon bucket handles tend to break, rust apart, and pull apart from their attachment point. For this reason, many approaches such as using a bucket handle for hoisting and lowering are employed with a substantial hazard created if the five gallon bucket handle is not properly attached to the devise hoisting and lowering the five gallon bucket. This procedure although widely used has several substantial drawbacks. First, hastily attached rope may not center correctly on the five gallon bucket handle and cause shifting and an off centered movement of the five gallon bucket thus causing instability in the hoisting and lowering of the five gallon buckets. Second, there is no standard weight rating of the five gallon bucket hoisted and lowered with the handle. This may lead to serious overloading of the capacity of the five gallon bucket and handle combination causing the handle to separate from the five gallon bucket resulting in a serious hazard from falling debris. The bucket sling resolves the hazardous issues related to the use of bent, broken, and loose fitting handles on five gallon buckets.

### SUMMARY OF THE INVENTION

The present invention provides for an easy consistent means for safely hoisting and lowering five gallon buckets. The bucket sling is a two piece webbing strap FIG. 1 used for raising and lowering containers. This design resolves the issues related to bent, broken and ripped out handles from the body of the five gallon bucket. Example of container to be carried in the bucket sling are five gallon plastic and or steel bucket and or pails. The bucket sling may be engaged with five gallon buckets of differing heights and circumferences. In an alternative embodiment the bucket sling may be affixed with five gallon bucket to a permanent or temporary stationary attachment point for storage or material collection, providing a safer system for the storage, suspension, and transportation of five gallon pails.

The bucket sling is constructed with of two main pieces the main strap and the alignment strap. FIG. 1 shows the main strap 1 which starts as an eyelet which is then looped around the handle 3 and follows under the base of the container up the other side stitched to the container circumference strap 4 and over the top of the five gallon bucket back through the eyelet 1 creating the handle. The material encircles the five gallon bucket circumference 4 where it meets up and is sewn to the eyelet of the main strap 1. Both ends of the alignment strap 5 are attached perpendicular to the circumference strap 4 that encompasses the entire five gallon bucket top. The bucket sling may be engaged with multiple size and diameter five gallon buckets. The Bucket sling may be made as durable as the specific application dictates. Though the embodiments describe herein are directed towards applications involving five gallon buckets other embodiments as described and disclosed in the specifications herein and directed to five gallon bucket sling as in no way limits the scope of the present invention.

### BRIEF DESCRIPTION OF THE DRAWINGS

The sling is constructed with of two main pieces the main strap and the alignment strap. Constructed of but not limited to; natural, synthetic, or steel materials in the form of webbing, rope, and cable. Fastened and attached by means of but not limited to; chemical glue, tape adhesive, heat welded, ultrasonic welding, mechanically riveted, sewn, bar tacked or burp tacked. The main strap constructed out of the same continuous section has four components.

FIG. 1 is a perspective view of the entire bucket sling as it sits empty it shows the four 1,2,3,4, components of the main strap and the single alignment strap 5.
1. The main strap with the eyelet shown at one end and the free end of the main strap passed through the eyelet then follows the circumference of the bucket and is which attached to the inside eyelet of the loop.
2. The base portion of the main strap which is connected to the alignment strap 5 on the bottom of the sling.
3. The handle is formed from the base portion of the main strap 2 as it follows up and crosses over the choker 4 and follows back down the other side and fed through eyelet 1 creating the start of the choker 4.
4. The choker and handle transition starts at the eyelet 1 and follows circumference of the five gallon bucket. The alignment strap which is attached onto it at opposite ends of the five gallon bucket and follows under the five gallon bucket to provide additional support.
5. The alignment strap 5 starts where it is connected to the choker 4 and follows down the side of the five gallon bucket where it crosses over the main strap at the base of the five gallon bucket where it is connected to the main strap base 2 and follows back up the opposite side where it is attached to the choker 4.

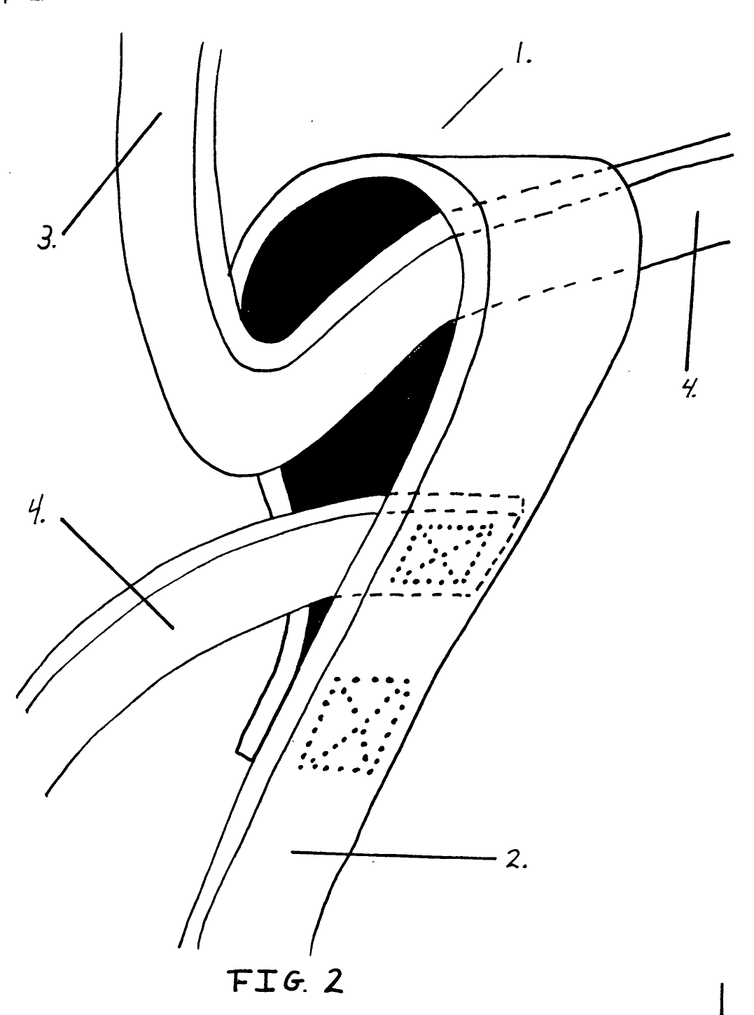

FIG. 2. Is a perspective view of the eyelet 1 and what parts make up the eyelet.
1. The main strap eyelet.
2. The start of the base portion of the main strap.
3. The end of the handle portion as it passes through the eyelet 1 and start the choker portion of the strap.
4. The end of the choker portion of the strap as it completes its circumference around the diameter of the bucket and is attached to the eyelet 1.

### EXEMPLARY EMBODIMENT

Referring now to the drawings, wherein like references numerals designate identical or corresponding parts throughout several views. FIG. 1 provides the main perspective view of the bucket sling. The main strap of the sling 1 starts at the rim of the five gallon bucket. The first loose end of the material is folded over to form an eyelet capable of receiving the width of the sling material to be inserted at a later point of the assembly. The sling eyelet is created with sufficient amount of material slack after its formation to include the width of the web and create an attachment point to complete the eyelet 1.

The base portion 2 of the main strap 1 begins at eyelet end of the material located at the rim of the five gallon bucket and follows down the side of the five gallon bucket. The sling material then follows under the bottom of the five gallon bucket where it will cross over the alignment strap 5 is attached and follows up the other side of the five gallon bucket to the opposite side of the rim attached to the choker 4 completing a full wrap of the underside of the five gallon bucket from one side of the rim to the opposite side of the rim. The intersection of the material will be attached at the bottom of the five gallon bucket where the alignment strap 5 crosses over the base 2 portion of the main strap. The end of the sling portion where it intersects with the choker 4 at the opposite rim of the five gallon bucket from eyelet will be attached perpendicular to the choker 4. The choker 4 and sling handle 3 transition are attached perpendicular to each other. The handle section of the main strap 3 starts at the intersection of the choker 4 and the end of the base portion of the main strap 2. The handle section of the sling carries over the top of the five gallon bucket to the opposite side from which it started 1 and fed through the eyelet 1. Additional material can be attached to the underside of the handle section to provide additional stability and strength. FIG. 2 provides a perspective view of the eyelet 1 at this intersection the handle 3 choker 4 transition is established. The choker portion 4 of the bucket sling starts at rim of the five gallon bucket where it passes through the eyelet 1 located at the end of the handle portion 3. The choker 4 of the bucket sling starts where the webbing protrudes through eyelet FIG. 2 main strap 1 after passing through the eyelet the choker section 4 material follows around the circumference of the rim of the five gallon bucket intersecting perpendicular to the handle start 3 and the end of the main strap base portion 2. At this intersection the material will be attached perpendicular to each other. The choker 4 section continues around the circumference of the five gallon bucket where it meets up with the eyelet 1. The end of the material as it completes the circumference of the rim of the five gallon bucket will be fed through the eyelet 1 and attached to complete the main strap of the bucket sling. The alignment portion 5 of the strap is a separate piece of material that begins attached to the choker 4 portion of the main strap located at rim of the container equidistant between beginning eyelet 1 portion of the choker 4 and attachment of the main sling base 2 and handle 3 transition point where it intersects with the choker opposite of eyelet. The alignment strap 5 follows down the side of five gallon bucket under the bottom of the five gallon bucket where it will cross over the main sling base 2 at this intersection the main sling base 2 and the alignment strap 5 are attached. The alignment strap 5 continues to follow up the other side of five gallon bucket to the opposite side of the rim of the five gallon bucket at the choker 4 completing a full wrap of the underside of the five gallon bucket from one side of the rim to the opposite side of the rim. The end of the alignment strap 5 is attached to the choker portion 4 of the main strap equidistant between eyelet 1 portion of the choker 4 and the attachment of the main base sling 2 and handle 3 transition point where it intersects perpendicular with the choker 4.

### ALTERNATIVE EMBODIMENTS

In an embodiment not shown here an addition, a clip, hasp, locking hook, or carabiner may be attached to the main portion of the handle to increase ease of attachment and detachment to hoisting line. The bucket sling includes many alternative embodiments of varying size and strength depending on the application for which the bucket sling is designed. Any suitable material known to those skilled in the art may be used to construct the bucket sling or any portions thereof for any embodiment described or pictures herein. For example man made materials such as nylon, Kevlar, carbon fiber, polyester, polypropylene, any combination thereof, or other suitable material may be used to construct the bucket sling. Additionally, natural materials such as hemp, sisal, manilla, cotton any combination thereof, or other suitable natural materials may be used to construct the bucket sling. The present invention is intended to apply to applications for transporting, hoisting, and lowering five gallon buckets. Modifications and alterations from the described embodiments will occur to those skilled in the art without departure from the spirit and scope of the present invention.

1. A two piece self aligning sling used to carry, haul, lift, hang, lower, raise, traverse, suspend a container.

2. The sling is a self aligning design that compensates for different size and diameter containers.

3. The sling uses a unique self tightening eyelet system that provides a sturdy compression grip around the rim of the container to hold it securely in place.

4. The bucket sling uses a two piece strap, the main strap which holds the container tight while the alignment strap keeps the other straps in place for hoisting.
